(19) United States
(12) Patent Application Publication
(10) Pub. No.: US 2020/0194212 A1
(43) Pub. Date: Jun. 18, 2020

(54) MULTILAYER X-RAY SOURCE TARGET WITH STRESS RELIEVING LAYER

(71) Applicant: General Electric Company, Schenectady, NY (US)

(72) Inventors: George Theodore Dalakos, Niskayuna, NY (US); Scott Andrew Weaver, Ballston Lake, NY (US); John Scott Price, Niskayuna, NY (US); Stephen Lourenco Araujo, Niskayuna, NY (US); Sathyanarayanan Raghavan, Ballston Lake, NY (US)

(73) Assignee: General Electric Company, Schenectady, NY (US)

(21) Appl. No.: 16/218,718

(22) Filed: Dec. 13, 2018

(51) Int. Cl. H01J 35/12

(52) U.S. Cl. CPC H01J 35/12; H01J 2235/084; H01J 2235/1291

(57) ABSTRACT

An X-ray source target includes a structure configured to generate X-rays when impacted by an electron beam. The structure has an X-ray generating layer comprising X-ray generating material, and a thermally-conductive layer is adjacent to and in thermal communication with the X-ray generating layer. A stress relieving layer is adjacent to the thermally-conductive layer. The thermally-conductive layer is sandwiched between the X-ray generating layer and the stress relieving layer.

### FIELD OF THE INVENTION

The subject matter disclosed herein relates to x-ray targets. Specifically, the subject matter disclosed herein relates to multilayer x-ray targets having a high thermal conductivity layer and a stress relieving layer.

### BACKGROUND OF THE INVENTION

A variety of medical diagnostic, laboratory, security screening, and industrial quality control imaging systems, along with certain other types of systems (e.g., radiation-based treatment systems), utilize X-ray tubes as a source of radiation during operation. Typically, the X-ray tube includes a cathode and an anode. An electron beam emitter within the cathode emits a stream of electrons toward an anode that includes a target that is impacted by the electrons.

A large portion of the energy deposited into the target by the electron beam produces heat within the target, with another portion of the energy resulting in the production of X-ray radiation. Indeed, only about 1% of the energy from the electron beam X-ray target interaction is responsible for X-ray generation, with the remaining 99% resulting in heating of the target. The X-ray flux is, therefore, highly dependent upon the amount of energy that can be deposited into the source target by the electron beam within a given period of time. However, the relatively large amount of heat produced during operation, if not mitigated, can damage the X-ray source (e.g., melt the target). Accordingly, conventional X-ray sources are typically cooled by either rotating or actively cooling the target. However, when rotation is the means of avoiding overheating, the amount of deposited heat along with the associated X-ray flux is limited by the rotation speed (RPM), target heat storage capacity, radiation and conduction cooling capability, and the thermal limit of the supporting bearings. Tubes with rotating targets also tend to be larger and heavier than stationary target tubes. When the target is actively cooled, such cooling generally occurs relatively far from the electron beam impact area, which in turn significantly limits the electron beam power that can be applied to the target. In both situations, the restricted heat removal ability of the cooling methods markedly lowers the overall flux of X-rays that are generated by the X-ray tube.

With this in mind, certain approaches may employ a layered X-ray source configuration, where layers of X-ray generating material are interleaved with layers of heat-conductive material to facilitate heat dissipation. One example may be a multi-layer diamond tungsten structure, where the tungsten generates X-rays when impacted by an electron beam and the diamond conducts heat away. Such a multilayer tungsten-diamond target structure is capable of producing high X-ray flux density due suitable heat dissipation, and is consequently able to withstand higher electron-beam irradiation than a conventional target structure. However, such a multi-layer structure may suffer from delamination of the layers in an operational setting. For example, adhesion between the X-ray generating and heat conducting layers may be inadequate during operation due to insufficient interfacial chemical bonding between layers.

### BRIEF DESCRIPTION OF THE INVENTION

A first aspect is an X-ray source target that includes a structure configured to generate X-rays when impacted by an electron beam. The structure has an X-ray generating layer comprising X-ray generating material, and a thermally-conductive layer is adjacent to and in thermal communication with the X-ray generating layer. A stress relieving layer is adjacent to the thermally-conductive layer. The thermally-conductive layer is sandwiched between the X-ray generating layer and the stress relieving layer.

A second aspect is an X-ray source target having a structure configured to generate X-rays when impacted by an electron beam. The structure includes a substrate, and a stress relieving layer formed on the substrate. A thermally-conductive layer is formed on the stress relieving layer. An X-ray generating layer comprises X-ray generating material, and the X-ray generating layer is formed on the thermally-conductive layer. The thermally-conductive layer is sandwiched between the X-ray generating layer and the stress relieving layer.

A third aspect is a method for manufacturing a multi-layer X-ray source target. The method includes a first forming step for forming a thermally-conductive substrate, and a second forming step for forming a stress relieving layer on the thermally-conductive substrate. A third forming step forms a thermally-conductive layer on the stress relieving layer, and a fourth forming step forms an X-ray generating layer on the thermally-conductive layer. The thermally-conductive layer is sandwiched between the X-ray generating layer and the stress relieving layer.

### BRIEF DESCRIPTION OF THE DRAWINGS

These and other features of this invention will be more readily understood from the following detailed description of the various aspects of the invention taken in conjunction with the accompanying drawings that depict various embodiments of the disclosure, in which:

FIG. 1 is a block diagram of an X-ray imaging system, in accordance with aspects of the present disclosure;

FIG. 2 depicts a generalized view of the incident electron beam as it relates to the thermal spot on the target surface and the optical spot seen by the detector, in accordance with aspects of the present disclosure;

FIG. 3 depicts a cut-away perspective view of an X-ray source having a target layer, thermally-conductive layer and stress relieving layer, in accordance with aspects of the present disclosure; and

FIG. 4 illustrates a flowchart for a method for manufacturing a multi-layer X-ray source target, in accordance with aspects of the present disclosure.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments. The term “adjacent” is defined as lying near, close, or contiguous, adjoining, neighboring or touching, however it is to be understood that adjacent may also be defined as near but with intervening interstitial layers (e.g., bonding layers, etc.).

As noted above, the X-ray flux produced by an X-ray source may depend on the energy and intensity of an electron beam incident on the source's target region. The energy deposited into the target produces, in addition to the X-ray flux, a large amount of heat. Accordingly, during the normal course of operation, a source target is capable of reaching temperatures that, if not tempered, can damage the target. The temperature rise, to some extent, can be managed by convectively cooling, also referred to as “direct cooling”, the target. However, such cooling is macroscopic and does not occur immediately adjacent to the electron beam impact area where damage i.e. melting, can occur. Without microscopic localized cooling, the overall flux of X-rays produced by the source is limited, potentially making the source unsuitable for certain applications, such as those requiring high X-ray flux densities. Rotating the target such that the electron beam distributes the energy over a larger area can reduce the target temperature locally, but it typically requires larger evacuated volumes and the additional complexity of rotating components such as bearings. Further, vibrations associated with rotating targets become prohibitive for high resolution applications where the required spot size is on the order of the amplitude of the vibration. Accordingly, it would be desirable if the source could be operated in a substantially continuous basis in a manner that enables the output of high X-ray flux.

The present disclosure provides embodiments of systems including an X-ray source having features configured to reduce thermal buildup in the X-ray source and to reduce cracking in the top X-ray producing layer. For example, certain of the embodiments discussed herein include a multi-layer X-ray source having a top X-ray generation layer (i.e., target layer), a middle thermal-conduction material disposed in thermal communication with the X-ray generating materials (within the target layer), and a bottom stress relieving layer in contact and in thermal communication with the stress relieving layer. As used herein, a target layer may include a layer or film of X-ray generating material extending in a continuous (i e, uninterrupted or unbroken) manner across the target layer at a given depth or elevation.

The thermal-conduction materials that are in thermal communication with the X-ray generating material, generally have a higher overall thermal conductivity than the X-ray generating material. The one or more thermal-conduction materials may be disposed below the topmost target layer. The thermal-conduction layer may generally be referred to as a “heat-dissipating” or “heat-spreading” layer, as it is generally configured to dissipate or spread heat away from the X-ray generating material impinged on by the electron beam to enable enhanced cooling efficiency. Having better heat conduction within the source target (i.e., anode) allows the end user to operate the source target at higher powers or smaller spot sizes while maintaining the source target at the same target operational temperatures. Alternatively, the source target can be maintained at lower temperatures at the same X-ray source power levels, thus increasing the operational lifetime of the source target. The former option translates into higher throughput as higher X-ray source power results in quicker measurement exposure times or improved feature detectability as smaller spot sizes results in smaller features being distinguishable. The latter option results in lower operational (variable) expenses for the end user as targets or tubes (in the case where the target is an integral part of the tube) will be replaced at a lower frequency. The stress relieving layer reduces high stress states in the upper two layers (i.e., the X-ray generating layer and the thermally-conductive layer) and demonstrates lower steady state temperatures. The stress relieving layer enables the use of higher power levels, which translates into increased scanning speed and increased part throughput, as well as increased scanning resolution. A further benefit of the stress relieving layer is that the target has increased lifetime due to the elimination or reduction of cracking in the X-ray generating layer and/or the thermally-conductive layer. The limited number of layers also reduces the opportunity for delamination, as may occur with targets having more layers if disparate material.

X-ray sources as discussed herein may be based on a stationary (i.e., non-rotating) anode structure or a rotating anode structure and may be configured for either reflective or transmissive X-ray generation. As used herein, a transmission-type arrangement is one in which the X-ray beam is emitted from a surface of the source target opposite the surface that is subjected to the electron beam. Conversely, in a reflection arrangement, the angle at which X-rays leave the source target is typically acutely angled relative to the perpendicular to the source target. This effectively increases the X-ray density in the output beam, while allowing a much larger thermal spot on the source target, thereby decreasing the thermal loading of the target.

By way of an initial example, in one implementation an electron beam is preferentially absorbed by an X-ray generating (e.g., tungsten) layer or region. After being absorbed in the X-ray generating region, X-ray photons and heat are produced. The majority of the absorbed energy is translated into heat. The underlying thermally-conductive material carries away the heat much more effectively than X-ray generating material. This reduces the heat concentration within the x-ray producing material. The bottom stress relieving layer reduces the thermal stresses in the above two X-ray generating layer and thermally-conductive layer, and protects the substrate layer (e.g., copper) from overheating and melting. Since the maximum temperature within the X-ray generating material is reduced, the power of the electron beam (and the corresponding X-ray generation) can be increased or the spot size can be reduced versus a conventional design without melting the X-ray generating region. The increase in power results in faster sample inspection or longer life. The reduction in spot size results in smaller feature detectability and improved resolution.

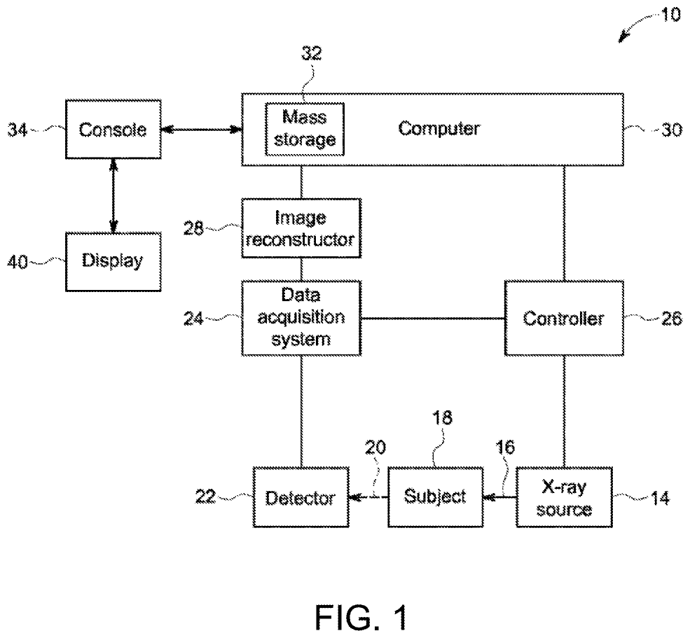

With the preceding in mind, and referring to FIG. 1, an X-ray imaging system 10 is shown as including an X-ray source 14 that projects a beam of X-rays 16 through a subject 18 (e.g., a patient or an item undergoing security or quality control inspection). It should be noted that while the imaging system 10 may be discussed in certain contexts, the X-ray imaging systems disclosed herein may be used in conjunction with any suitable type of imaging context or any other X-ray implementation. For example, the system 10 may be part of a fluoroscopy system, a mammography system, an angiography system, a standard radiographic imaging system, a tomosynthesis or C-arm system, a computed tomography system, and/or a radiation therapy treatment system. Further, the system 10 may not only be applicable to medical imaging contexts, but also to various inspection systems for industrial or manufacturing quality control, part inspection, luggage and/or package inspection, and so on. Accordingly, the subject 18 may be a laboratory sample, (e.g., tissue from a biopsy), a patient, luggage, cargo, manufactured parts, nuclear fuel, or other material of interest.

The subject may, for example, attenuate or refract the incident X rays 16 and produce the projected X-ray radiation 20 that impacts a detector 22, which is coupled to a data acquisition system 24. It should be noted that the detector 22, while depicted as a single unit, may include one or more detecting units operating independently or in conjunction with one another. The detector 22 senses the projected X-rays 20 that pass through or off of the subject 18, and generates data representative of the radiation 20. The data acquisition system 24, depending on the nature of the data generated at the detector 22, converts the data to digital signals for subsequent processing. Depending on the application, each detector 22 produces an electrical signal that may represent the intensity and/or phase of each projected X-ray beam 20.

An X-ray controller 26 may govern the operation of the X-ray source 14 and/or the data acquisition system 24. The controller 26 may provide power and timing signals to the X-ray source 14 to control the flux of the X-ray radiation 16, and to control or coordinate with the operation of other system features, such as cooling systems for the X-ray source, image analysis hardware, and so on. In embodiments where the system 10 is an imaging system, an image reconstructor 28 (e.g., hardware configured for reconstruction) may receive sampled and digitized X-ray data from the data acquisition system 24 and perform high-speed reconstruction to generate one or more images representative of different attenuation, differential refraction, or a combination thereof, of the subject 18. The images are applied as an input to a processor-based computer 30 that stores the image in a mass storage device 32.

The computer 30 also receives commands and scanning parameters from an operator via a console 34 that has some form of operator interface, such as a keyboard, mouse, voice activated controller, or any other suitable input apparatus. An associated display 40 allows the operator to observe images and other data from the computer 30. The computer 30 uses the operator-supplied commands and parameters to provide control signals and information to the data acquisition system 24 and the X-ray controller 26.

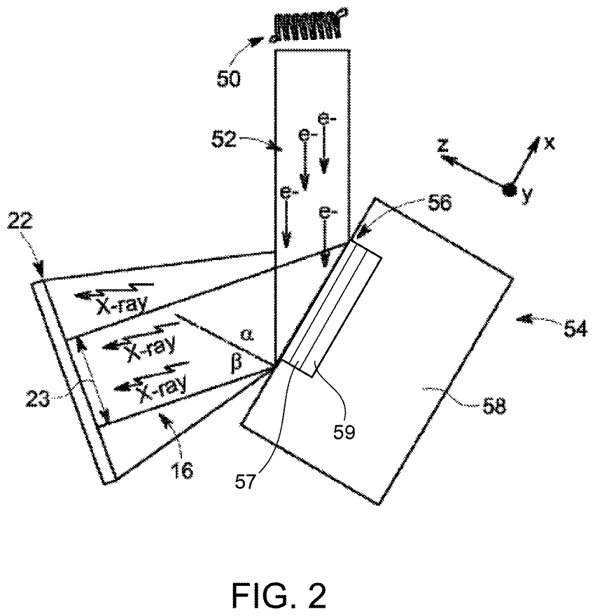

Referring now to FIG. 2, a high level view of components of an X-ray source 14, along with detector 22, are depicted. The aspects of X-ray generation shown are consistent with a reflective X-ray generation arrangement that may be consistent with either a rotating or stationary anode X-ray source 14. In the depicted implementation, an X-ray source 14 includes an electron beam emitter (here depicted as an emitter coil 50) that emits an electron beam 52 toward a target region of X-ray generating material/layer 56. The X-ray generating layer 56 may be a high-Z material, such as one or more of tungsten, rhenium, rhodium, and molybdenum, or any other material or combinations of materials capable of emitting X-rays when bombarded with electrons). The source target may also include one or more thermally-conductive materials, such as substrate 58, or thermally conductive layers or other regions surrounding the X-ray generating material. As used herein, a region of X-ray generating material 56 is generally described as being encompassed by a target layer or X-ray generating layer of the source target, where the X-ray generating layer has some corresponding thickness, which may vary for different X-ray generating layers within a given source target.

The electron beam 52 incident on the X-ray generating layer 56 generates X-rays 16 that are directed toward the detector 22 and which are incident on the detector 22, the optical spot 23 being the area of the focal spot projected onto the detector plane. The electron impact area on the X-ray generating layer 56 may define a particular shape, thickness, or aspect ratio on the source target (i.e., anode 54) to achieve particular characteristics of the emitted X-rays 16. For example, the emitted X-ray beam 16 may have a particular size and shape that is related to the size and shape of the electron beam 52 when incident on the X-ray generating layer 56. Accordingly, the X-ray beam 16 exits the source target 54 from an X-ray emission area that may be predicted based on the size and shape of the impact area. In the depicted example the angle between the electron beam 52 and the normal to the target is defined as α. The angle β is the angle between the normal of the detector and the normal to the target. Where b is the thermal focal spot size at the target region 56 and c is optical focal spot size, b=c/cos β. Further, in this arrangement, the equivalent target angle is 90−β.

As discussed in greater detail below, various embodiments, employ a multi-target layer source target 54 having an X-ray generating layer 56 in the z-dimension that is in contact with a thermally-conductive layer 57, which is in contact with a stress relieving layer 59, wherein the thermally-conductive layer is sandwiched between the X-ray generating layer 56 and the stress relieving layer 59. The substrate layer 58 is formed of a material having thermal conductivity, as may be a copper material or alloy. Such a multi-layer source target 54 (e.g. anode) (including the respective layers and/or intra-layer structures and features discussed herein) may be fabricated using any suitable technique, such as suitable semiconductor manufacturing techniques including vapor deposition (such as chemical vapor deposition (CVD)), sputtering, atomic layer deposition, chemical plating, ion implantation, or additive or reductive manufacturing such as in high rate deposition coating techniques such as plasma arc deposition or plasma spray deposition, and so on.

Referring to FIG. 2, generally the thermally-conductive layer 57 has a thermal conductivity that is higher than those exhibited by the X-ray generating target material/layer. By way of non-limiting example, a thermal-conducting layer 57 may include carbon-based materials including but not limited to highly ordered pyrolytic graphite (HOPG), diamond, and/or metal-based materials such as beryllium, beryllium oxide (BeO), and aluminum nitride, or any combination thereof. Alloyed materials such as silver-diamond may also be used. Table 1 below provides the composition, thermal conductivity, coefficient of thermal expansion (CTE), density, and melting point of some example thermally-conductive materials for layer 57.

TABLE 1

| | | | CTE | | |
|---|---|---|---|---|---|
| | | Thermal | ppm/K (@ | | Melting |
| | | Conductivity | Room | Density | Point |
| Material | Composition | W/m-K | Temp) | g/cm³ | ° C. |
| Diamond | Poly crystalline | 1200 | 1.5 | 3.5 | 3550 |
| | diamond | | | | |
| Beryllium | BeO | 250 | 7.5 | 2.9 | 2578 |
| oxide | | | | | |
| HOPG | C | 1700 | 0.5 | 2.25 | N/A |

It should be noted that the different thermally-conductive layers, structures, or regions within a source target 54 may have correspondingly different thermally-conductive compositions, different thicknesses, and/or may be fabricated differently from one another, depending on the respective thermal conduction needs at a given region within the source target 54. However, even when differently composed, such regions, if formed so as to conduct heat from the X-ray generating materials, still constitute thermally-conductive layers (or regions) as used herein. Further, as discussed herein, in various embodiments respective depth (in the z-dimension) within the source target 54 may determine the thickness of X-ray generating material found at that depth, such as to accommodate the electron beam incident energy expected at that depth. That is, layer or regions of X-ray generating material formed at different depths within a source target 54 may be formed so as to have different thicknesses.

In certain embodiments, the X-ray generating material or layer 56 found within a given layer of the source target 54 may be provided over a limited extent relative to the effective surface area of the source target 54 when viewed in cross-section in a given x-y, plane, e.g., as a discrete “plug” or a “ring” within a respective layer formed in the x-y plane. In particular, studies performed in support of the present document have shown that limiting the active X-ray generating layer 56 to the size of the electron beam 52 (i.e., a plug) can allow an increase in the maximum power. In such an arrangement, heat transfer may be facilitated away from the limited area X-ray generating layer/region 56 by thermally-conductive layers below the X-ray generating layer 56, but also by thermally-conductive material disposed laterally (i.e., within the same layer.

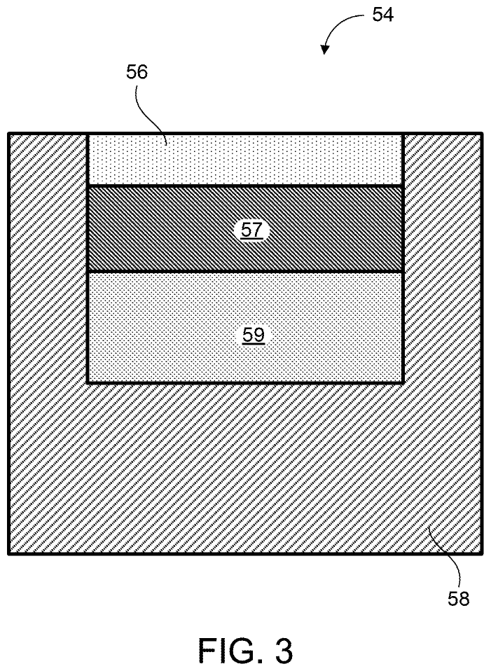

FIG. 3 depicts a cut-away perspective view of an X-ray source 54 having an X-ray generating layer 56, thermally-conductive layer 57, and stress relieving layer 59, in accordance with aspects of the present disclosure. The X-ray source target 54, includes a structure configured to generate X-rays when impacted by an electron beam. This structure includes an X-ray generating layer 56 formed of X-ray generating material. A thermally-conductive layer 57 is adjacent to, in contact with and in thermal communication with the X-ray generating layer 56. The thermally-conductive layer 57 is formed underneath the X-ray generating layer 56. A stress relieving layer 59 is formed adjacent to, in contact with and underneath the thermally-conductive layer 57. In effect, the thermally-conductive layer 57 is sandwiched between the X-ray generating layer 56 and the stress relieving layer 59. The substrate 58 is a thermally-conductive substrate supporting the X-ray generating layer 56, the thermally-conductive layer 57 and the stress relieving layer 59, and may be formed of copper or copper alloys.

The X-ray generating layer 56 is formed of one or more of tungsten, molybdenum, titanium-zirconium-molybdenum alloy (TZM), tungsten-rhenium alloy, copper-tungsten alloy, chromium, iron, cobalt, copper, or silver. As one example only, the X-ray generating layer 56 is formed of tungsten and may be about 0.1 mm deep and have a length/width and/or diameter of about 20 mm. If an electron beam 450 kV source operating at about 100 μm to 2,000 μm, then the electron bean will penetrate about 100 μm into the X-ray generating layer 56. However, the thickness of the X-ray generating layer 56 may range from about 40 μm to about 0.2 mm, or any suitable thickness as desired in the specific application above or below the listed range.

The thermally-conductive layer 57 is formed of carbon-based materials including but not limited to highly ordered pyrolytic graphite (HOPG), diamond, and/or metal-based materials such as beryllium oxide (BeO), silicon carbide (SiC), copper-molybdenum (Cu—Mo), oxygen-free high thermal conductivity copper (OFHC), or any combination thereof. As one example only, the thermally conductive layer 57 is bonded to the bottom of X-ray generating layer 56 and is formed of diamond, and layer 57 may be about 40 μm to about 1.2 mm in thickness. However, the thickness of thermally-conductive layer 57 may be any suitable thickness as desired in the specific application.

The stress relieving layer 59 is formed of one or more of tungsten, molybdenum, titanium-zirconium-molybdenum alloy (TZM), tungsten-rhenium alloy, copper-tungsten alloy, chromium, iron, cobalt, copper, or silver. As one example only, the stress relieving layer 59 is formed of tungsten and may be about 1 mm deep and have a length/width and/or diameter of about 20 mm. All three layers are contained within and supported by substrate 58, which may be formed of copper or copper alloys. The stress relieving layer 59 is bonded to the bottom of the thermally-conductive layer 57 and functions to relieve stresses in both the thermally-conductive layer 57 and the X-ray generating layer 56. Stresses in the various layers may cause cracking therein, and cracks reduce the lifetime of the target 54, so it is desirable if cracking can be avoided or at least delayed for a substantial amount of time. Layers 56, 57 and 59, and any target layers for that matter, may be bonded together by brazing, via adhesive, or by direct deposition using a vapor or liquid deposition approach. Material processing steps such as deposition thermal excursions or brazing process steps causes stress in the layers during the associated heat-up and cool-down cycles. The layers 56, 57 also experience thermal expansion and contraction stresses during operation of the target. These thermally induced stresses can cause delamination and cracking to occur in the layers. The addition of the stress relieving layer 59 greatly alleviates the stresses experienced by X-ray generating layer 56 and thermally-conductive layer 57 by moderating the temperature differentials induced in the X-ray generating layer 56 and thermally-conductive layer 59. Stress relieving layer 59 (due to its thermal conductivity properties) permits more heat to be directed to substrate 59 in a controlled manner so that overheating of the substrate does not occur and temperature differentials in the above two layers (i.e., X-ray generating layer 56 and thermally-conductive layer 57) are moderated to desirable levels, thereby resulting in overall stress mitigation in target 54. Note that direct deposition of layers is preferred in the x-ray generating layer to high conductive layer due to high operating temperatures that that interface will experience.

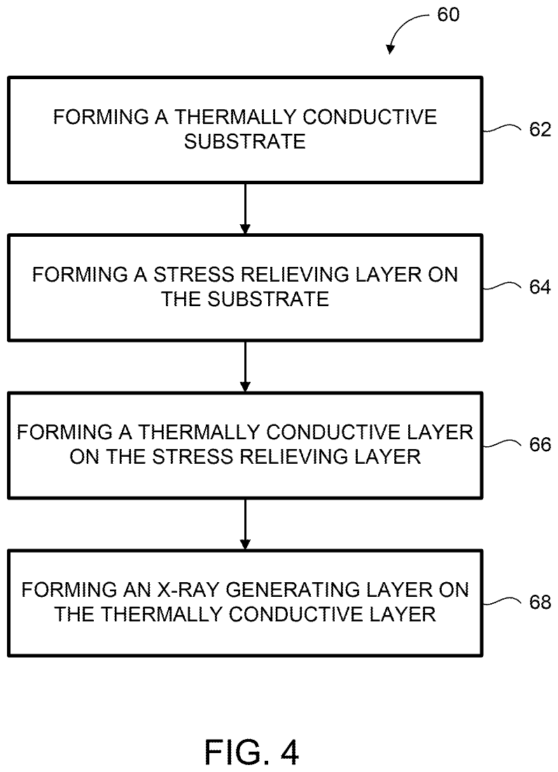

FIG. 4 illustrates a flowchart for a method 60 for manufacturing a multi-layer X-ray source target 54. The method 60 includes a forming step 62 that forms or provides a thermally-conductive substrate 58. Step 62 may include providing or forming a copper substrate. Another forming step 64 forms a stress relieving layer 59 on the thermally-conductive substrate 58. The stress relieving layer 59 is one or more of tungsten, molybdenum, titanium-zirconium-molybdenum alloy (TZM), tungsten-rhenium alloy, copper-tungsten alloy, chromium, iron, cobalt, copper, silver. Brazing or adhesive may be used to bond the stress relieving layer 59 to the substrate 58. In step 66, a thermally-conductive layer 57 is formed on the stress relieving layer 59. The thermally-conductive layer 57 is one or more of highly ordered pyrolytic graphite (HOPG), diamond, beryllium oxide, silicon carbide, copper-molybdenum, copper, tungsten-copper alloy, or silver-diamond. Brazing or adhesive may be used to bond the thermally-conductive layer 57 to the stress relieving layer 59. In step 68, an X-ray generating layer 56 is formed on the thermally-conductive layer 57. The X-ray generating layer 56 is one or more of tungsten, molybdenum, titanium-zirconium-molybdenum alloy (TZM), tungsten-rhenium alloy, copper-tungsten alloy, chromium, iron, cobalt, copper, silver. Direct deposition may be used to bond the X-ray generating layer 56 to the thermally-conductive layer 57. A result of the above method is that the thermally-conductive layer 57 is sandwiched between the X-ray generating layer 56 and the stress relieving layer 59. The X-ray generating layer 56 may be directly deposited on the thermally-conductive layer 57 by a thermal arc deposition source. The intimate resulting bond from thermal arc deposition can withstand very high operational temperatures that a brazed joint cannot.

Technical effects of the present embodiments include, but are not limited to a multi-layer source target structure capable of operating at high temperatures with reduced stresses and reduced likelihood of cracking. Certain technical embodiments include a single layer of X-ray generating material formed on top of a single thermally-conductive layer, which is formed on top of a single stress relieving layer imbedded in copper or other high thermal conductivity material, or the X-ray generating layer comprises a single layer of tungsten, the thermally-conductive layer comprises a single layer of diamond, and the stress relieving layer comprises a single layer of tungsten. As disclosed herein, the X-ray generating structures are not limited in terms of focal spot size or kV, and thus may apply to focal spots between 100 μm to 1,000 μm, as well as to other focal spot sizes, as well as to 100 kV to 450 kV (or greater) applications.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An X-ray source target, comprising:
a structure configured to generate X-rays when impacted by an electron beam, the structure comprising:
an X-ray generating layer comprising X-ray generating material;
a thermally-conductive layer adjacent to and in thermal communication with the X-ray generating layer; and
a stress relieving layer adjacent to the thermally-conductive layer; and
wherein the thermally-conductive layer is sandwiched between the X-ray generating layer and the stress relieving layer.

2. The X-ray source target of claim 1, wherein the X-ray generating layer comprises one or more of tungsten, rhenium, rhodium and molybdenum.

3. The X-ray source target of claim 1, wherein the thermally-conductive layer comprises one or more of highly ordered pyrolytic graphite (HOPG), diamond, beryllium oxide, beryllium, and aluminum nitride.

4. The X-ray source target of claim 1, wherein the stress relieving layer comprises one or more of tungsten, molybdenum, titanium-zirconium-molybdenum alloy (TZM), tungsten-rhenium alloy, copper-tungsten alloy, chromium, iron, cobalt, copper, silver.

5. The X-ray source target of claim 1, wherein the X-ray generating layer comprises tungsten, the thermally-conductive layer comprises diamond, and the stress relieving layer comprises tungsten.

6. The X-ray source target of claim 1, wherein the X-ray generating layer comprises a single layer of tungsten, the thermally-conductive layer comprises a single layer of diamond, and the stress relieving layer comprises a single layer of tungsten.

7. The X-ray source target of claim 1, further comprising a thermally-conductive substrate supporting the X-ray generating layer, the thermally-conductive layer and the stress relieving layer.

8. The X-ray source target of claim 7, wherein the thermally conductive substrate is comprised of copper.

9. An X-ray source target, comprising:
a structure configured to generate X-rays when impacted by an electron beam, the structure comprising:
a substrate;
a stress relieving layer formed on the substrate;
a thermally-conductive layer formed on the stress relieving layer;
an X-ray generating layer comprising X-ray generating material, the X-ray generating layer formed on the thermally-conductive layer; and
wherein the thermally-conductive layer is sandwiched between the X-ray generating layer and the stress relieving layer.

10. The X-ray source target of claim 9, wherein the X-ray generating layer comprises one or more of tungsten, rhenium, rhodium and molybdenum.

11. The X-ray source target of claim 10, wherein the thermally-conductive layer comprises one or more of highly ordered pyrolytic graphite (HOPG), diamond, beryllium oxide, beryllium, and aluminum nitride.

12. The X-ray source target of claim 11, wherein the stress relieving layer comprises one or more of tungsten, molybdenum, titanium-zirconium-molybdenum alloy (TZM), tungsten-rhenium alloy, copper-tungsten alloy, chromium, iron, cobalt, copper, silver.

13. The X-ray source target of claim 9, wherein the X-ray generating layer comprises tungsten, the thermally-conductive layer comprises diamond, and the stress relieving layer comprises tungsten.

14. The X-ray source target of claim 9, wherein the X-ray generating layer comprises a single layer of tungsten, the thermally-conductive layer comprises a single layer of diamond, and the stress relieving layer comprises a single layer of tungsten.

15. The X-ray source target of claim 9, wherein the substrate is comprised of copper.

16. A method for manufacturing a multi-layer X-ray source target, the method comprising:
forming a thermally-conductive substrate;
forming a stress relieving layer on the thermally-conductive substrate;
forming a thermally-conductive layer on the stress relieving layer;
forming an X-ray generating layer on the thermally-conductive layer; and
wherein the thermally-conductive layer is sandwiched between the X-ray generating layer and the stress relieving layer.

17. The method of claim 16, wherein the thermally-conductive substrate is comprised of copper.

18. The method of claim 16, wherein the stress relieving layer comprises one or more of tungsten, molybdenum, titanium-zirconium-molybdenum alloy (TZM), tungsten-rhenium alloy, copper-tungsten alloy, chromium, iron, cobalt, copper, silver.

19. The method of claim 18, wherein the thermally-conductive layer comprises one or more of highly ordered pyrolytic graphite (HOPG), diamond, beryllium oxide, beryllium, and aluminum nitride.

20. The method of claim 19, wherein the X-ray generating layer comprises one or more of tungsten, rhenium, rhodium and molybdenum.

21. The method of claim 19, wherein the X-ray generating layer is directly deposited on the thermally-conductive layer by a thermal arc deposition source.
